(19) United States
(12) Patent Application Publication
(10) Pub. No.: US 2015/0099480 A1
(43) Pub. Date: Apr. 9, 2015

(54) MOBILE TERMINAL WITH PROGRAMMABLE REDUCED FUNCTIONALITY

(71) Applicant: JOEL MICHAEL REITER, VIRGINIA BEACH, VA (US)

(72) Inventor: JOEL MICHAEL REITER, VIRGINIA BEACH, VA (US)

(21) Appl. No.: 14/510,808

(22) Filed: Oct. 9, 2014

Related U.S. Application Data
(60) Provisional application No. 61/888,821, filed on Oct. 9, 2013.

(51) Int. Cl. H04M 1/725; H04W 76/00; H04B 1/38; H04W 4/02

(52) U.S. Cl. CPC H04M 1/72577; H04W 4/027; H04W 4/021; H04W 76/007; H04B 1/3888
USPC 455/404.1; 455/418

(57) ABSTRACT

An application is provided that runs on a mobile terminal (MT) that reduces the functionality of the MT while the holder or user of the MT, such as a relatively inexperienced driver, is aboard a moving vehicle. According to a further aspect of the embodiments the application substantially prevents cellular phone use of the MT by school students while on school premises, or some other geographical limitation (such as in a religious institution, government building, among others). According to a further aspect of the embodiments the application substantially prevents illicit tracking of a cell phone owned or otherwise operated by a person, such as a covert operator or an anti-terrorist official, whose movements should not be illicitly monitored. According to further aspects of the embodiments the application substantially ensures that in the event a user enters an emergency number into the MT the user is then able to use the MT even if the MT was previously shut down or its functionality reduced in line with different aspects of the embodiments.

### PRIORITY INFORMATION

The present application claims priority under 35 U.S.C. §119(e) to U.S. Provisional Patent Application Ser. No. 61/888, 821, filed Oct. 9, 2013, the entire contents of which are expressly incorporated herein by reference.

### TECHNICAL FIELD

The embodiments described herein relate generally to applications that run on mobile terminals, and more specifically to systems, methods, and modes for applications that run on mobile terminals that can prohibit hazardous use thereof.

### BACKGROUND

It is now well known to many people that texting or surfing the web through use of a mobile communication device (also known as a “mobile terminal”) such as a cell phone while driving, can be significantly dangerous, particularly with respect to new drivers such as teenage drivers. Such use has been shown to cause distractions that deleteriously impact the ability of the driver to respond to traffic conditions. Such distractions can lead to greater risk of accidents such as rear end collisions at stop signs, or red traffic lights. For example, a driver of a vehicle who is texting may not notice vehicles waiting at a red traffic light, and rear end a vehicle in front of them, or may violently swerve into another traffic lane to avoid a collision that could result in a side impact with a vehicle waiting in another lane.

According to the U.S. Government's website on distracted driving, http://www.distraction.gov/content/get-the-facts/facts-and-statistics.html, the number of people killed in distraction-affected crashes in 2011 numbered 3360. In 2012, the number of fatalities decreased only slightly to 3,328 in 2012. However, an estimated 421,000 people were injured in motor vehicle crashes involving a distracted driver, which was a nine percent increase from the estimated 387,000 people injured in 2011. Distracted drivers are defined on the website as those that engage in the activities of “texting, using a cell phone or smartphone, eating and drinking, talking to passengers, grooming, reading (including maps), using a navigation system, watching a video, and adjusting a radio, CD player, or MP3 player.” But, the Government's website makes the point that “because text messaging requires visual, manual, and cognitive attention from the driver, it is by far the most alarming distraction.”

Parents typically pay for their teenagers' auto insurance and cell phone usage and are naturally concerned that their offspring don't engage in distracting acts such as texting while driving a vehicle. While teenagers have been maligned for such behavior, such transgressions are not limited to those in their “teens” but seems to afflict those of the age that grew up with mobile terminals or devices such as tablets, cell phones, and the like. Regardless of which age group is predominantly to blame, if there is one, it is apparent that there is a need for a mobile devices that prevents all drivers from miss-using a cell phone while driving. Consequently, there exists prior art that attempts to limit mobile device use while driving.

For example, U.S. Pat. No. 7,856,203 describes a system that allegedly prevents moving vehicle drivers from cell phone texting while that vehicle is moving. This system comprises a motion detector and a moving vehicle's contiguous interior compartment containing at least four courtesy signal transmitters and at least one conventional cell phone having a text keyboard, a microphone, and a courtesy signal receiver disposed in the microphone that is in the keyboard. This compartment may also have devices in it that control the speed and direction the moving vehicle will go, and if so, it may have a moving vehicle driver, who may also be the aforementioned cell phone user, located to operate these devices. The cell phone may enable or disable the keyboard based on courtesy signal transit times and the motion indicator, but this determination may be overridden by the cell phone service provider, or person of authority located in the vehicle's contiguous interior compartment.

In U.S. Published Patent Application No. 2009/0221279, there is described a method and apparatus for controlling use of mobile communication devices while operating a vehicle, wherein the mobile communication device (MCD) of the '279 Application uses one or more ways to determine its speed while moving in order to alter the default behavior of the device based on a stored safety policy. Using existing technologies, such as an accelerometer, the MCD described in the '279 Application determines the current or last known position using a global positioning system (GPS), assisted GPS (AGPS), location-based services (LBS), global system for mobile (GSM), and/or code division multiple access (CDMA) state of motion, to modify the behavior of the MCD based on its speed and a stored safety policy. The human interface of the MCD is altered to inform the user of the modification, features and functions that can be disabled and enabled, the user is prompted to change their behavior, and automatic functions take place. The logging functions of the MCD can allegedly be enhanced to record the motion state of the MCD while using any feature of the MCD.

U.S. Published Patent Application No. 2007/0072616 describes a method that allegedly prevents cellular phone usage while driving. In one embodiment, a GPS system incorporated into the workings of the cellular phone is used to detect that the phone is in motion, and that the rate of movement exceeds some preset value indicating that the phone is in a moving vehicle. Having detected motion, the phone will deliver a number of options ranging from complete shutdown until motion stops, to use only for emergency purposes, to only limited use, or to complete use by interjecting a preset PIN or other such password that will allow the cellular phone user to override the phone shutdown mechanism. Other alternate means for detecting motion include triangulation between numerous towers, to signal strength variation from a single tower, to signals generated by miniature accelerometers and velocity-meters imbedded in the phone specifically for detecting rate of movement.

U.S. Published Patent Application No. 2009/0215466 describes a method implemented on a mobile phone that will allegedly disable a cellular phone to prevent incoming, outgoing, or re-route incoming, cellular phone calls/text/video/messages and the like if the cellular phone is known to be moving at a predetermined speed corresponding to an unsafe operation of a vehicle. The system and method will allegedly determine if the cellular phone is travelling at the predetermined speed, and if so will alert the user, then perform any one or all of, a set of predetermined actions such as shutdown of the phone, re-route of all of the calls to voice mail, store all of the text messages, shutdown of the display, prevent outbound calling/texting, and the like. The system and method of the '466 Application allegedly prevents an individual from using their cellular phone while operating a moving vehicle at or above a predetermined speed.

U.S. Pat. No. 8,195,188 describes a method that allegedly blocks GPS reporting with respect to remote receiving units (such as pagers and cellular phones). The '188 patent includes a location reporting paging communication system comprising space satellites, ground stations and a remote receiving unit adapted to resolve a global position from signals transmitted from a communication transmitter. The subscriber in possession of the remote receiving unit updates the paging network with global positioning information. A caller paging a subscriber in possession of the remote receiving unit may request the global location of the remote receiving unit. The paging network could divulge or block such information from a caller depending on the requirements of the subscriber.

While all of the above attempt to prevent use of mobile devices in potentially dangerous circumstances, certain problems still exists in these and other prior art attempts. Accordingly, it would be desirable to provide methods, modes, and systems for applications that run on mobile terminals that can prohibit hazardous use thereof while operating a moving vehicle.

### SUMMARY

An object of the embodiments is to substantially solve at least the problems and/or disadvantages discussed above, and to provide at least one or more of the advantages described below.

It is therefore a general aspect of the embodiments to provide systems, methods, and modes that will obviate or minimize problems of the type previously described.

The aspects of the embodiments relate generally to mobile terminals (MTs) such as cell phones. According to an aspect of the embodiments, an application is provided that runs on a MT that reduces the functionality of the MT while the holder or user of the MT, such as a relatively inexperienced driver, is aboard a moving vehicle. According to a further aspect of the embodiments the same or different application substantially prevents cellular phone use of the MT by school students while on school premises, or some other geographical limitation (such as in a religious institution, government building, among others). According to a further aspect of the embodiments the same or different application substantially prevents illicit tracking of a cell phone owned or otherwise operated by a person, such as a covert operator or an anti-terrorist official, whose movements should not be illicitly monitored. According to further aspects of the embodiments the same or different application substantially ensures that in the event a user enters an emergency number into the MT the user is then able to use the MT even if the MT was previously shut down or its functionality reduced in line with different aspects of the embodiments.

According to a first aspect of the embodiments, a method for reducing functionality of a mobile terminal is provided, the method comprising: monitoring a speed of a mobile terminal (502); determining that the speed of the mobile terminal exceeds a predetermined threshold (504) and reducing the functionality of the mobile terminal until the speed falls below the predetermined threshold (506); and determining that the speed of the mobile terminal does not exceed the predetermined threshold (504) and continuing to monitor the speed of the mobile terminal without reducing the functionality of the mobile terminal (508). According to the first aspect, the step of reducing the functionality of the mobile terminal comprises: shutting down one or more of the functions of receiving and placing calls, receiving and sending text messages, using an internet web browser, receiving and sending electronic mail messages, taking and viewing photos, downloading data and/or applications, and playing games.

According to the first aspect of the embodiments, the mobile terminal comprises: one of a cellular telephone, a tablet, a laptop, and a personal digital assistant, and further wherein the cellular telephone comprises one of a third generation (3G) communications protocol cellular telephone, a fourth generation (4G) communications protocol cellular telephone, and 4G-long term evolution (LTE) communications protocol cellular telephone.

According to the first aspect of the embodiments, the step of determining that the speed of the mobile terminal exceeds a predetermined threshold comprises: setting the predetermined threshold on the basis of a moving vehicle, and wherein the step of monitoring a speed of the mobile terminal comprises: using a position determining unit of the mobile terminal to determine and monitor the speed of the mobile terminal.

According to the first aspect of the embodiments, the step of using a position determining unit comprises: receiving and processing on a substantially continuous basis global positioning system signals to ascertain a position, and a change in position over time, so that an average speed of the mobile terminal can be substantially constantly ascertained.

Still further according to the first aspect of the embodiments, the step of using a position determining unit further comprises: using an inertial navigation system to augment the ascertainment of the position and speed of the mobile terminal, and further wherein the step of using a position determining unit further comprises: using cellular based positioning determining processes to augment the ascertainment of the position and speed of the mobile terminal.

According to a second aspect of the embodiments, a method for reducing functionality of a mobile terminal (600) is provided, the method comprising: determining a location of the mobile terminal (608); and reducing the functionality of the mobile terminal if the location of the mobile terminal matches that of a predetermined list of locations wherein usage of the mobile terminal is substantially prohibited.

According to the second aspect of the embodiments, the method further comprises: determining a date and time of a usage of the mobile terminal; and reducing the functionality of the mobile terminal if the current date and time is such that usage of the mobile terminal is substantially prohibited at the determined location of the mobile terminal.

According to the second aspect of the embodiments, the predetermined list of locations comprises one or more of a school, religious institution, and government building, and further wherein the date and time of usage that is substantially prohibited comprises one of a normal work day and working times, and a normal school day and school attendance times.

According to a third aspect of the embodiments, a method for reducing functionality of a mobile terminal (700) is provided, the method comprising: monitoring a speed of a mobile terminal (702); determining that the mobile terminal is operated by a protected person (704); and continuing to monitor the speed of the mobile terminal and reducing a position determining functionality of the mobile terminal (706).

According to the third aspect of the embodiments, the method further comprises: determining that the mobile terminal is not operated by a protected person (704); determining that the speed of the mobile terminal exceeds a predetermined threshold (708) and reducing the functionality of the mobile terminal until the speed falls below the predetermined threshold (710); and determining that the speed of the mobile terminal does not exceed the predetermined threshold (708) and continuing to monitor the speed of the mobile terminal without reducing the functionality of the mobile terminal (712).

According to a fourth aspect of the embodiments, a method for alleviating a reduction in functionality of a mobile terminal (800) is provided, the method comprising: reducing the functionality of the mobile terminal; checking one or more keystrokes entered by a user of the mobile terminal (802); determining that an emergency number has been dialed by comparing the entered keystrokes to a plurality of stored emergency numbers (804); and returning full functionality to the mobile terminal upon the determination that the entered keystrokes are that of a stored emergency number (806).

According to the fourth aspect of the embodiments, the method further comprises: determining that an emergency number has not been dialed, and continuing to maintain the reduced functionality of the mobile terminal (804).

According to a fifth aspect of the embodiments, a method for reducing functionality of a mobile terminal (900) is provided, the method comprising: monitoring a speed and location of a mobile terminal (902); determining that the speed of the mobile terminal indicates that the mobile terminal is aboard a moving vehicle (904); obtaining a list of regulations governing usage of the mobile terminal while aboard a moving vehicle (908) at the location of the moving vehicle; determining that the mobile terminal is in a location that prohibits usage of the mobile terminal while aboard the moving vehicle (910); and reducing the functionality of the mobile terminal (912).

According to the fifth aspect of the embodiments, the method further comprises: determining that the speed of the mobile terminal does not indicate that the mobile terminal is on board a moving vehicle (904); and continuing to monitor the speed of the mobile terminal without reducing the functionality of the mobile terminal (906).

According to the fifth aspect of the embodiments, the method further comprises: determining that the mobile terminal is in a location that does not prohibits usage of the mobile terminal while aboard the moving vehicle (910); and continuing to monitor the speed of the mobile terminal without reducing the functionality of the mobile terminal (902).

According to a sixth aspect of the embodiments, a reduced functionality charging apparatus (1300) for a mobile terminal (100) is provided, comprising: a cable and connector (1304) adapted to connect the charging apparatus to a direct current source for charging the mobile terminal; a case (1308) adapted to retain and hold within itself the mobile terminal and to provide interconnections to provide for charging of the mobile terminal; and a cover (1306) adapted to be controlled by a circuit (1316) to substantially cover and prevent access to the mobile terminal, and wherein the circuit is adapted to close the cover upon determining that the mobile terminal is at least one of (a) moving on board a vehicle, and (b) charging. According to the fifth aspect of the embodiments, the reduced functionality charging apparatus further comprises: a connected adapted to plug directly into the direct current source without an intervening cable (1302) for charging the mobile terminal.

### BRIEF DESCRIPTION OF THE DRAWINGS

The above and other objects and features of the embodiments will become apparent and more readily appreciated from the following description of the embodiments with reference to the following FIG.s, wherein like reference numerals refer to like parts throughout the various FIG.s unless otherwise specified, and wherein:

FIG. 1 illustrates a high level block diagram of a mobile terminal within which one or more applications can be stored and used to provide reduced functionality of a mobile terminal according to aspects of the embodiments.

FIG. 2 illustrates a simplified front view of the mobile terminal of FIG. 1 according to an aspect of the embodiments.

FIG. 3 illustrates a block diagram of a positioning determining unit/motion detection system for use in the mobile terminal of FIGS. 1 and 2 according to aspects of the embodiments

FIG. 4 illustrates a simplified block diagram of a network that the mobile terminal of FIGS. 1 and 2 can be operated within according to an aspect of the embodiments.

FIG. 5 illustrates a flow chart of a method for substantially preventing an inexperienced driver from being distracted, or distracting others, through the use of a mobile terminal while in a moving vehicle according to an aspect of the embodiments.

FIG. 6 illustrates a flow chart of a method for substantially preventing use of a mobile terminal by a user based on geographical proximity to locations wherein such mobile terminal use is generally societally offensive or legally not allowed according to an embodiment.

FIG. 7 illustrates a flow chart of a method for substantially preventing illicit tracking of a cell phone owned or otherwise operated by a protected person, such as an undercover police officer, covert operator, or anti-terrorist official, whose movements should not be illicitly monitored, according to an aspect of the embodiments.

FIG. 8 illustrates a flow chart of a method for substantially ensuring emergency use of a mobile terminal at substantially any time by substantially anyone according to aspects of the embodiments.

FIG. 9 illustrates a flow chart of a method for substantially reducing the functionality of a mobile terminal as a function of speed, location and cell phone usage laws while driving or moving within a locality according to an aspect of the embodiments.

FIG. 10 illustrates a perspective view of a mobile terminal charging station according to an aspect of the embodiments.

FIG. 11 illustrates a perspective view of another mobile terminal charging station according an aspect of the embodiments.

FIG. 12 illustrates a perspective view of the mobile terminal charging stations of FIGS. 10 and 11 with a mobile terminal in the mobile terminal charging station of FIG. 10 according to an aspect of the embodiments.

FIGS. 13, 14, 15, and 16 illustrate several perspective views of another mobile terminal charging station according to a further aspect of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments can, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The following embodiments are discussed, for simplicity, with regard to the terminology and structure of a mobile terminal, such as a cell phone, or so-called “smart phone.” However, the embodiments to be discussed next are not limited to these systems but can be applied to other personal mobile devices such as tablets, personal digital assistants, laptops, among other devices, wherein usage under certain circumstances, or in certain locations, can be problematic, illegal and/or dangerous.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics can be combined in any suitable manner in one or more embodiments.

According to embodiments, the problems described above can be addressed by, for example, an application that runs on a mobile terminal (MT) that reduces the functionality of the MT while the holder or user of the MT, such as a relatively inexperienced driver, is aboard a moving vehicle. According to a further aspect of the embodiments the same or different application substantially prevents cellular phone use of the MT by school students while on school premises, or some other geographical limitation (such as in a religious institution, government building, among others). According to a further aspect of the embodiments the same or different application substantially prevents illicit tracking of a cell phone owned or otherwise operated by a person, such as a covert operator or an anti-terrorist official, whose movements should not be illicitly monitored. According to further aspects of the embodiments the same or different application substantially ensures that in the event a user enters an emergency number into the MT the user is then able to use the MT even if the MT was previously shut down or its functionality reduced in line with different aspects of the embodiments.

Used throughout the specification are several acronyms, the meanings of which are provided as follows:
3G Third Generation
4G Fourth Generation
AGPS Assisted GPS
App Application
AP Application Processor
BT Bluetooth
CDC Center for Disease Control
CDMA Code Division Multiple Access
DC Direct Current
GPS Global Positioning System
GSM Global System for Mobile
IEEE Institute of Electrical and Electronics Engineers
INS Inertial Navigation System
ISP Internet Service Provider
LBS Location-Based Services
LED Light Emitting Diode
LTE Long Term Evolution
MCD Mobile Communication Device
MDS Motion Detection System
MEMS Micro-Electro-Mechanical Systems
MODEM Modulator-Demodulator
MPH Miles-per-Hour
MT Mobile Terminal
MTCS Mobile Terminal Charging Station
MTRF Mobile Terminal Reduced Functionality
NFC Near field communications
PC Personal Computer
PDU Position Determining Unit
USB Universal Serial Bus
WLAN Wireless Local Area Network

The following is a list of the elements of the Figures in numerical order:
100 Mobile Terminal (MT)
102 Mobile Terminal Reduced Functionality (MTRF) Application (App)
104 Processor
106 Display Screen
108 Audio System
110 Cellular Communications System Transceiver
112 Wi-Fi Transceiver
114 Bluetooth Transceiver
116 Near Field Communications Transceiver
118 User Interface
120 Positing Determining Unit/Motion Detection System
122 Memory
124 Antenna
126 Internal Data/Communications Bus
202 Inertial Navigation System
204 Global Positioning System Receiver
400 Network
404 PC/Laptop
406 Internet Service Provider
407 Modulator/Demodulator (MODEM)
408 Server
409 Wireless Router
410 Plain Old Telephone Service Provider
414 Cellular Service Provider Network
416 Internet
418 GPS Satellite
1000 Mobile terminal charging station
1002 Cradle
1004 Adaptors
1006 Lighter Plug
1100 Mobile terminal charging station
1102 USB connector computer adaptor
1103 USB cable
1104 USB Connector
1106 Smart Phone Input
1108 Cell Phone Input
1110 USB Input
1112 Power Indicator
1114 LED Indicator
1300 Mobile Terminal Charging Station
1302 First Lighter Plug
1304 Charging Cable
1306 Sliding Cover
1308 Case
1310 USB Port
1312 USB Cable Connector
1314 Cable Lighter Plug
1316 Charging Station Circuitry

Aspects of the embodiments relate generally to mobile terminals (MTs) such as, but not limited to, cell phones (e.g., Samsung Galaxy, Android, and Apple iPhone series of smart phones), and limiting their use or functionality depending on different circumstances, or allowing different limited usage according to other circumstances, according to various aspects of the embodiments.

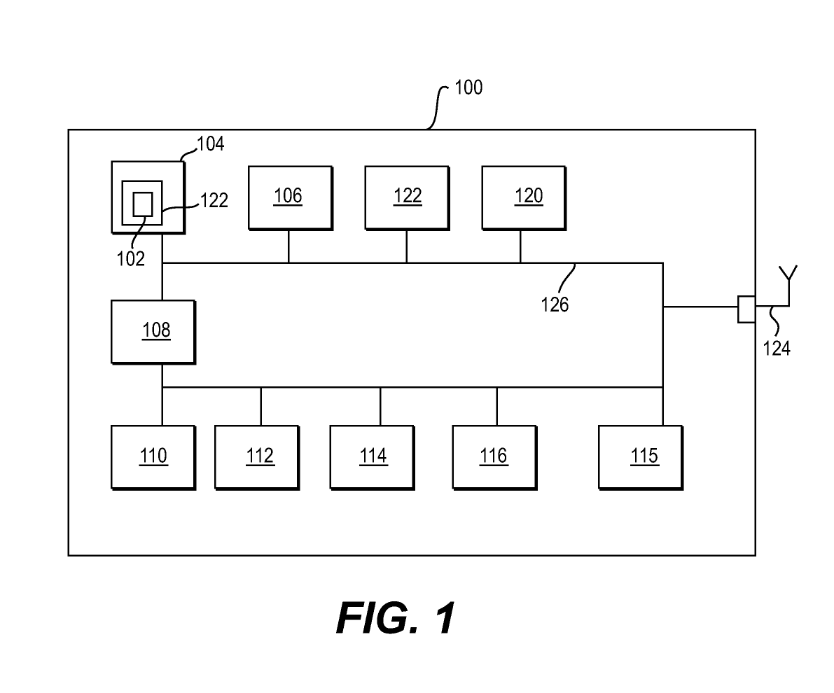

FIG. 1 illustrates a high level block diagram of mobile terminal 100 within which one or more applications can be stored and used to provide reduced functionality of mobile terminal (MT) 100 according to aspects of the embodiments.

FIG. 1 illustrates a functional block diagram of MT 100 for use with the system and methods provided herein according to aspects of the embodiments for reducing functionality of MT 100. In the following description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

FIG. 1 shows MT 100 that includes position determining unit (PDU)/motion detection system (MDS) 120 configured to ascertain and verify a position and movement of a user of MT 100 for use with the system and methods described herein, for example with mobile terminal reduced functionality (MTRF) application (App) 102 according to aspects of the embodiments. MT 100 includes application processor (AP) 104 that executes one or more applications to, for example, reduce functionality of MT 100 under certain circumstances. Such applications can be stored in the form of code, or computer enabling instructions, stored in one or many different types of memory 122. According to an embodiment, one such application (App) is MTRF App 102. MRTF App 102 is an application that can be stored on one or more of a mobile phone, laptop, tablet, or any other portable electronic device that can cause, or potentially can cause distractions to the operator of a vehicle, or other apparatus, and which can also provide other functionality that can reduce the functionality of MT 100 according to further aspects of the embodiments. As will become apparent to those of skill in the art in the following discussion, MRTF App 102 encompasses several different functional aspects; as those of the art can further appreciate, such functional aspects can be divided into several different Apps, or combined in different combinations according to further aspects of the embodiments. However, in fulfilment of the dual purposes of clarity and brevity, MTRF App 100 will be generally described as a single App that can be stored in memory 122 of MT 100 (whether in one or more separate memory devices, or within memory internal to processor 104), and accessed and used by processor 104, as described below. Nonetheless, such single instance of MTRF App 102, as well as any sub-combinations thereof, are to be considered to be within the different aspects of the embodiments.

Processor 104 and memory 122, whether located internally or externally to processor 104, can be used to implement methods 500, 600, 700, 800, and 900 for reducing or enabling functionality on mobile terminals 100, as described in greater detail below, according to aspects of the embodiments. Hardware, firmware, software or a combination thereof can be used to perform the various steps and operations described herein. According to an embodiment, MTRF App 102 for carrying out the above discussed steps can be stored in memory 122.

MT 100 further includes processor 104, audio system 108, radio frequency (RF) transceiver (or more generally “cellular communications system”) 110, Wi-Fi transceiver 112, Bluetooth transceiver 114, near field communications transceiver 116, user interface 118, PDU/MDS 120, display screen 106 (which can be combined with user interface 118 in the form of a touch screen), and internal data/communications bus 126. The operation and use of these functions/devices within MT 100 are or should be well known to those of skill in the art, and as such a detailed discussion thereof has been omitted in fulfilment of the dual purposes of clarity and brevity.

MT 100 includes one or more air interfaces, such as near field communications (NFC) transceiver 116, Wi-Fi transceiver 112 (e.g., wireless local area network (WLAN) products that are based on the Institute of Electrical and Electronics Engineers' (IEEE) 802.11 standard), and Bluetooth (BT) transceiver 114. Cellular communications transceiver 110 (using third generation (3G), fourth generation (4G or long term evolution (LTE)) communication protocols), can communicate with cellular networks. Bluetooth 114, Wi-Fi 112, and cellular protocols are wireless communication protocols.

MT 100 further includes display/data entry unit 106, 118 that is commonly in the form of a touchscreen display in many of the currently available MTs 100. Data/command bus 126, which is shown in a greatly simplified form in FIG. 1, transfers data to and from the various communication interfaces, as well as to and from application processor 104, PDU/MDS 120, and display/data entry unit 106, 118. It is further understood by those of skill in the art that each of the communication interfaces, i.e., cellular communications interface 110, Wi-Fi 112, BT 114, NFC 116, and PDU/MDS 120, can have their own or shared antennas 124, which have been collectively shown as a single antenna 124 for the sake of clarity and precision.

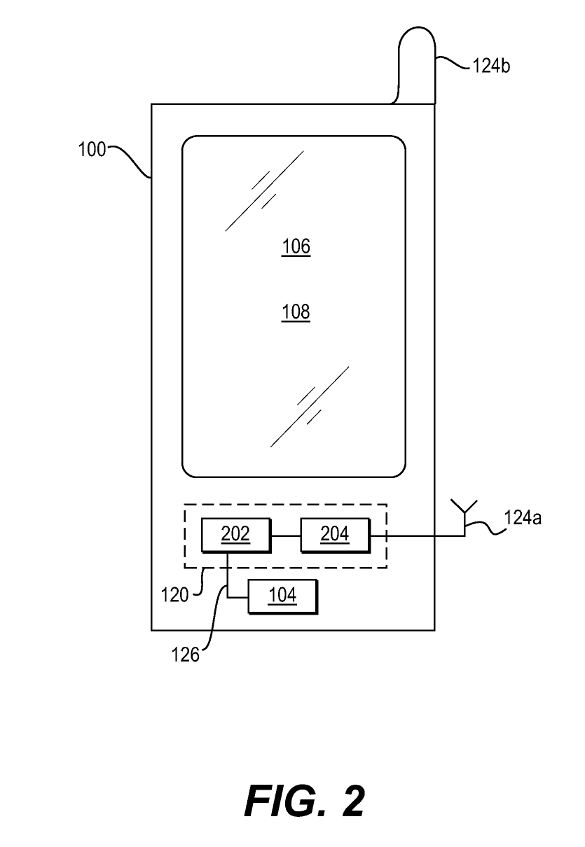

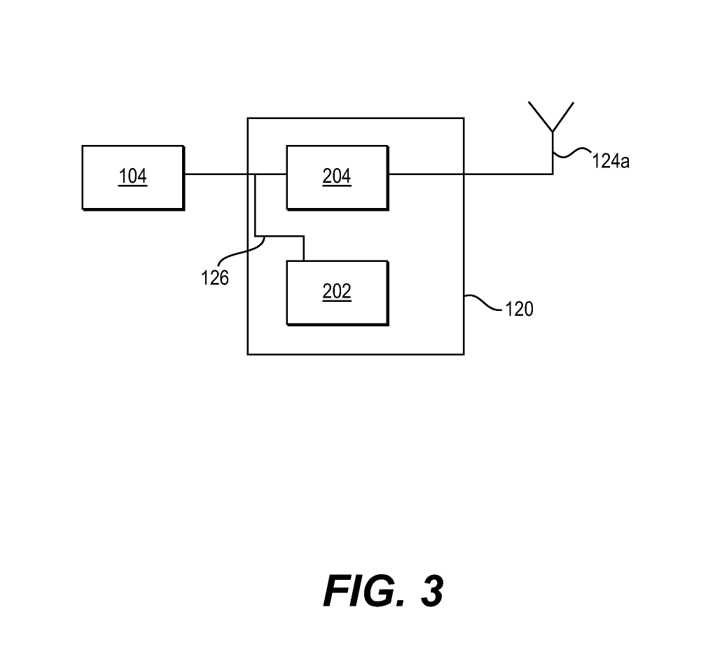

FIG. 2 illustrates a simplified front view of mobile terminal 100 of FIG. 1 according to an aspect of the embodiments, and FIG. 3 illustrates a block diagram of positioning determining unit/motion detection system 120 for use in mobile terminal 100 of FIGS. 1 and 2 according to further aspects of the embodiments. As shown in FIGS. 2 and 3, MT 100 includes PDU/MDS 120 that comprises inertial navigation system 202 and global positioning system 204 according to an embodiment. PDU/MDS 120 is connected to antenna 124a in both FIGS. 2 and 3. MT 100 comprises antenna 124b that can be used for cellular communications, such as that which can be facilitated by interfacing with cellular transceiver 110. PDU/MDS 120 operates according to well-known principles, the detailed discussion of which is not necessary to understand the aspects of the embodiments; those of skill in the art can appreciate that MT 100 can ascertain its positon by use of GPS 204 that receives several signals from three or more GPS satellite transmitters placed in orbit about the earth. By carefully tracking position over time, velocity and acceleration can be determined by MT 100 and processor 104. Used in conjunction with well-known geographical position data, a fairly exact location of MT 100 can be ascertained, as well as tracking and displaying of movement along roads and highways, for example. In addition, MT 100 can ascertain movement by use of INS 202.

Inertial navigation systems use, in the case of MTs 100, accelerometers made in the form of integrated circuitry and can track velocity and acceleration over time, which can then be used to determine position and velocity over roads, and highways, for example. The circuitry that can be used to fabricate INS 202 is often referred to as “micro-electro-mechanical systems,” or MEMS, and is a technology that in its most general form can be defined as miniaturized mechanical and electro-mechanical elements (i.e., devices and structures) that are made using the techniques of micro-fabrication.

In addition, INS 202 can work with GPS 204 to correlate and confirm the data from each other; in this manner, positioning and velocity data can be continuously updated and verified. Further still, MT 100 can use one or more signals generated by one or more cellular network towers that is then processed by position determining software within processor 104. While such positioning determinations may be less certain than GPS, or perhaps INS, it too can be used to correlate and verify the data from the other two positioning and velocity/acceleration determining processes. In this manner, the three systems cross check each other's results.

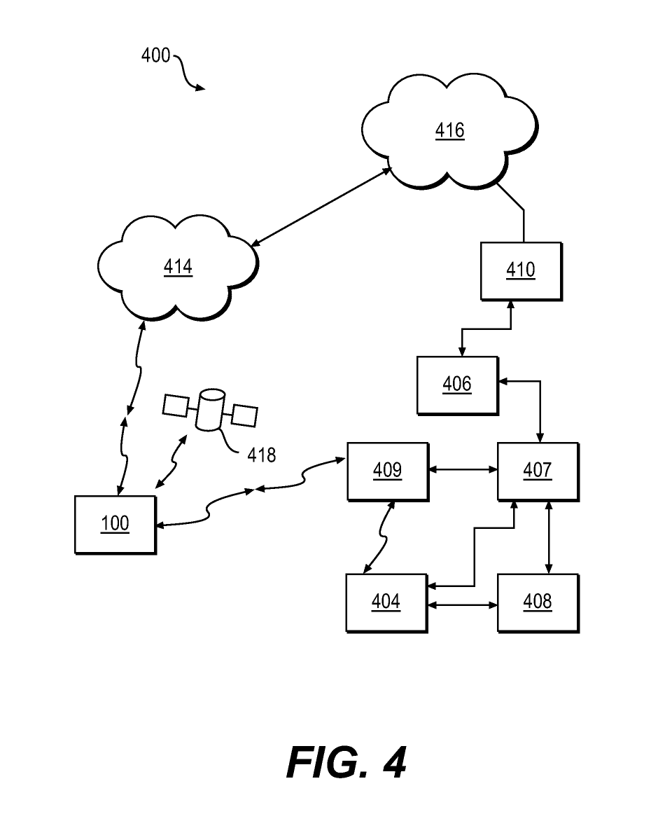

FIG. 4 illustrates a simplified block diagram of network 400 that mobile terminal 100 of FIGS. 1, 2, and 3 can operate within according to an aspect of the embodiments.

FIG. 4 illustrates network system 400 within which the system and method for reducing functionality in mobile terminals in MT 100 can be used according to an embodiment. Much of the network system infrastructure shown in FIG. 4 is or should be known to those of skill in the art, so, in fulfillment of the dual purposes of clarity and brevity, a detailed discussion thereof shall be omitted.

According to an embodiment, a user of the system and method for reducing functionality in mobile terminals in MT 100 has stored on MT 100 MTRF App 102 on their MTs 100. As described above, MTs 100 can include, but are not limited to, so-called smart phones, tablets, personal digital assistants, notebook and laptop computers, and essentially any device that can access the internet and/or cellular phone service or can facilitate transfer of the same type of data in either a wired or wireless manner. For purposes of this discussion, the user shall be discussed as using only MT 100 in the form of a smartphone, though such discussion should be understand to be in a non-limiting manner in view of the discussion above about the other types of devices that can access, use, and provide such information.

IN FIG. 4, the user operates MT 100, which can access cellular network 414, either through a wireless or wired interconnection. Further, as discussed below in greater detail, MT 100 can have near field communication (NFC), “Wi-Fi,” and Bluetooth (BT) communications capabilities as well. To that end, network system 400 further includes, as many homes (and businesses) do, server 408 and/or laptop/personal computer (PC) 404 that can be connected to wireless router (router) 409 via a wired or wireless connection. Also shown in FIG. 4 is modulator-demodulator (MODEM) 407, which is connected to internet service provider (ISP) 406, and provides signals in the appropriate format to end users, and which takes signals from the end users and forwards them to ISP 406. As those of skill in the art can appreciate, MT 100 can access cellular network 414 either directly wirelessly, or via router 409, through PC 404 and/or server 408 and ISP 406 and internet 416. Such communication pathways are well known and understand by those of skill in the art, and further detailed discussion thereof is thus unnecessary.

MT 100 can also access GPS 418, to obtain positioning information (useful for different aspects of the embodiments, as discussed above, and in greater detail below), or can obtain positioning information via cellular service provider 414 according to one or more well-known methods of position determination. Some MTs 100 can also access satellites (not shown) for near-universal communications capabilities, albeit at a much higher cost than conventional “terrestrial” cellular services. MT 100 can also obtain positioning information internal to a building (or arena/stadium) through the use of one or more NFC/BT devices, the details of which are generally known to those of skill in the art, and need not be repeated herein in fulfillment of the dual purposes of clarity and brevity. FIG. 4 also illustrates other components of network system 400 such as phone service provider 410 that can interface with ISP 406 and internet network 416, providing additional communication paths for MT 100 user.

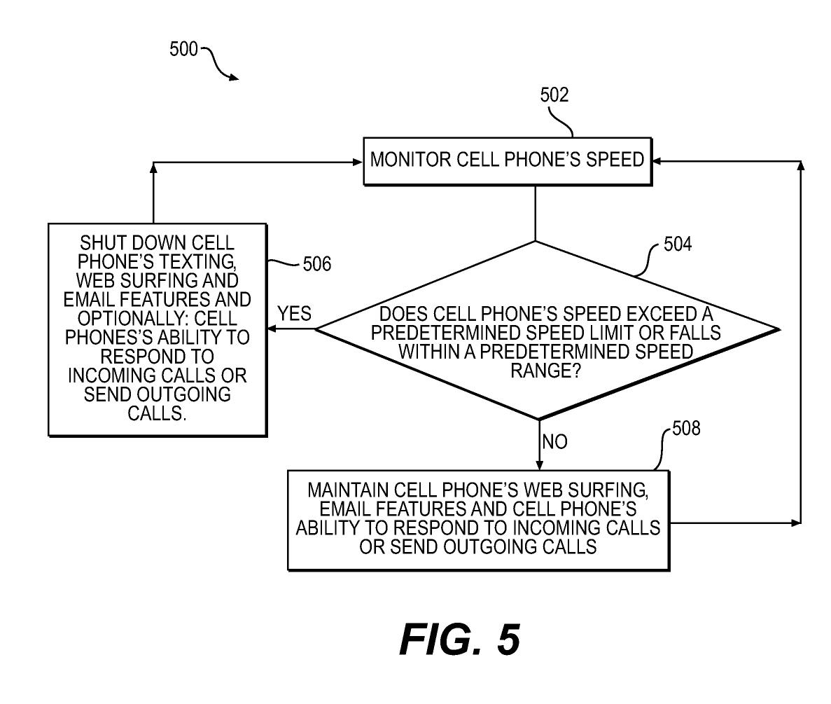

FIG. 5 illustrates a flow chart of method 500 for substantially preventing an inexperienced driver from being distracted, or distracting others, through the use of mobile terminal 100 while in a moving vehicle according to an aspect of the embodiments. Method 500 begins with method step 502, in which MTRF 102 monitors a speed that MT 100 is moving or traveling at. As described above, this occurs though use of PDU/MDS 120 and interaction with processor 102 and MTRF App 102 according to aspects of the embodiments. That is, MTRF 102 monitors the speed of MT 100 by periodically checking the output of PDU/MDS 120, which provides the velocity of MT 100 according to one or more of the methods described above in regard to FIGS. 1, 2, 3, and 4.

Following the determination of the speed of MT 100, method 500 determines in decision step 504 whether the speed of MT 100 exceeds a predetermined speed, or falls within a predetermined range. According to an embodiment, the predetermined threshold is set to correlate to normal minimum moving speeds of a vehicle, such as a car, truck, or the like. That is, the predetermined speed according to an embodiment is faster than that of a person walking or jogging, but slow enough to capture a vehicle that is moving fast enough so that it can reasonably be ascertained that MT 100 is in a vehicle that is moving. It is known that the fastest person in the world at this time can move at about 28 mile-per-hour, for very short periods of time. Therefore, the predetermined threshold can be set, according to one, non-limiting example, to about 25 MPH, which is a typical minimum speed for many streets in the U.S.

If the speed of MT 100 exceeds a predetermined speed limit (“Yes” path from decision step 504), method 500 proceeds to method step 506 wherein MTRF 102 causes MT to reduce the functionality of certain operations of MT 100, such as prohibiting texting services, web surfing, access to email, among others, including responding and/or placing phone calls. As those of skill in the art can appreciate, the list of functions that can be limited by MTRF 102 according to aspects of the embodiments is not limited to those described above. Practically all or any combination of the functions of MT 100 can be limited by MTRF 100 in response to excessive speed of MT 100, and any such existing function, whether listed or not, or any other function that is or becomes available is considered to be within the aspects of the embodiments.

Following the limitations of the functions of MT 100 in method step 506, method 500 continues to method step 502 to again monitor the speed of MT 100. If the speed reduces (e.g., the user of MT 100 pulls over to the side of the road to make a call, or respond to a text), then method 500 will allow the functionality to occur. This is the result of a “No” path from decision step 504, wherein method 500 determines that the speed of MT 100 does not exceed certain predefined or predetermined speed limits, and allows for the full functionality of MT 100 according to the aspects of the embodiments (method step 508). Following method step 508, method 500 returns to method step 502 wherein again the speed of MT 100 is monitored, and this process continues. As those of skill in the art can appreciate, the predefined speeds can be set by certain individuals with certain rights over MT 100, such as a parent of a child, or perhaps an employer that provides MTs 100 to their employees to use, and therefore has an interest in restricting usage as employees drive vehicles owned by the employer. According to further aspects of the embodiments, a court could impose an order that a person convicted of certain offenses have their MT 100 restricted in use in accordance with the aspects of the embodiments as described herein with regards to FIG. 5, and method 500, as well as the other aspects of the embodiments described herein.

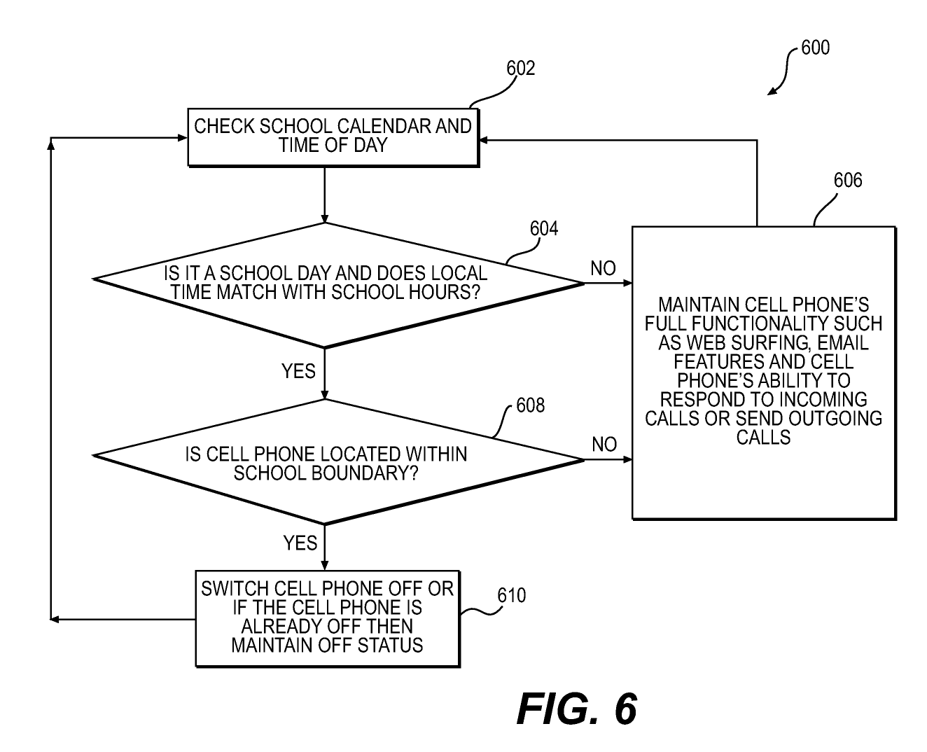

FIG. 6 illustrates a flow chart of method 600 for substantially preventing use of MT 100 by a user based on geographical proximity to locations wherein such MT 100 use is generally societally offensive or legally not allowed according to an embodiment. While method 600 is described as pertaining to use of (or prohibiting use of) MT 100 in or around a school, those of skill in the art can appreciate that with very little modification, the same method can be equally applied to other locations, such as in a religious institution (church, synagogue, mosque, and so on), government building (e.g., courthouse), or movie theater, among many other locations. All such facilities, and the changes required to implement method 600 thereto, are considered to be within the scope of the aspects of the embodiments. However, in fulfillment of the dual purposes of clarity and brevity, method 600 has been described, in a non-limiting manner, in regard to limiting usage of MT 100 when a user is in or about a school, at a date and time wherein such usage could be prohibited according to aspects of the embodiments.

Method 600 begins with method step 602 wherein MTRF 102 checks a calendar and time of day to ascertain whether it is a school day, and during school hours. In decision step 604, method 600 determines whether the ascertained time and date is a school time/day; if it is not (“No” path from decision step 604), method 600 proceeds to method step 606, and allows all of the functionality of MT 100 as may be contained therein. If it is a school day and it is within the normal time for school (“Yes” path from decision step 604), method 600 then proceeds to decision step 608, wherein it checks the location of MT 100 to ascertain its position (again, using PDU/MDS 120 according to aspects of the embodiments, as described above), to determine whether MT 100 is within the boundaries of the school. If MT 100 is not within the boundaries of the school (or other buildings, as the case may be; “No” path from decision step 608), method 600 proceeds to method step 606 wherein all of the functionality of MT 100 as may be contained therein.

If, however, MT 100 is determined to be within the school boundary (“Yes” path from decision step 608), then method 600 proceeds to method step 610 wherein MT 100 is turned off, or not allowed to be turned on. Then method 600 returns to method step 602 to substantially continuously monitor the position of MT 100, and the date and time to determine whether functionality of MT 100 should continue to be restrained according to aspects of the embodiments.

In another example of the use of method 600, an attorney can program their MT 100 to prohibit functionality of his/her MT 100 when in or near a courthouse. For example, the attorney could program MTRF 102 to not allow functionality of MT 100 Monday through Friday, during the hours of 0900-1800, at the Courthouse located on the corner of Main St. and First Ave, in Anytown, USA, zip code XXXXX. If the attorney happened to be attending a conference in the courthouse after hours, method 600 and MTRF 102 would not prohibit use of MT 100 according to aspects of the embodiments. But if the attorney was in court, at a hearing for example, and forgot to leave his/her MT 100 at home (many courthouses allow attorneys to bring their phones into courtrooms, but request that they be silenced before proceedings begin), then if it was during normal court hours, MT 100 would not operate through operation of MTRF 102 and method 600 according to aspects of the embodiments.

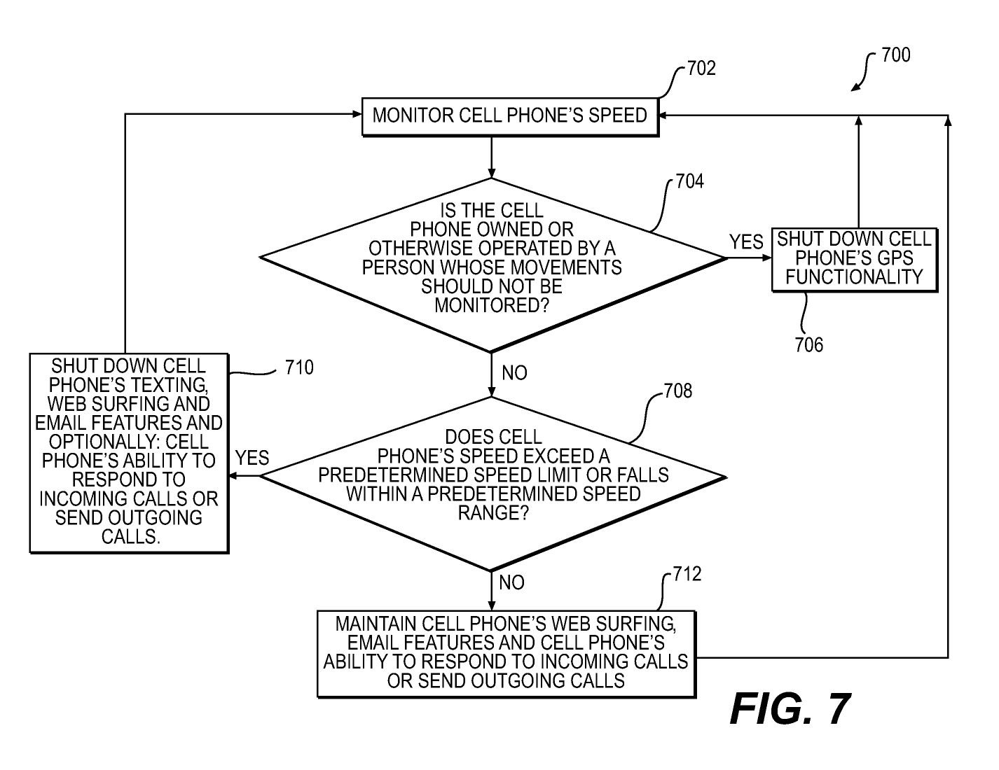

FIG. 7 illustrates a flow chart of method 700 for substantially preventing illicit tracking of MT 100 owned or otherwise operated by a protected person, such as an undercover police officer, covert operator, or anti-terrorist official, whose movements should not be illicitly monitored, according to an aspect of the embodiments. For the purposes of this discussion, the people listed or described above whose functionality might be limited by method 700 shall be referred to collectively as “protected people,” or the “protected person.” Method 700 begins with method 702, wherein a speed of MT 100 of a protected person is monitored. Then, in method step 704, method 700 determines whether MT 100 is owned by a protected person. According to an aspect of the embodiments, if MTRF 102 was loaded on all MTs 100 sold in the U.S., for example, then a government agency can establish a registry of MTs 100 that belong to certain protected people, and MT 100 could be informed that it belonged to such a protected person, or MTRF 102 could periodically check a database of a national or local registry, and ascertain that it belongs to a protected person in that manner.

If MT 100 is determined to belong to a protected person in decision step 704 (“Yes” path from decision step 704), then in method step 706, the GPS functionality (and/or other functions that determine a position of MT 100 (e.g., INS 202, and/or cellular based positioning determining processes) of MT 100 is shut down, and method 700 returns to method step 702. If, however, MT 100 does not belong to a protected person (“No” path from decision step 704), method 700 proceeds to method step 708 wherein it is determined if the speed of MT 100 exceeds a predetermined velocity. If the speed of MT 100 exceeds the predetermined velocity (“Yes” path from decision step 708), method 700 proceeds to method step 710 and the functionality of MT 100, as described above in regard to method 500, is restricted. Method 700 then returns to method step 702 to ascertain the speed of MT 100 according to aspects of the embodiments. If the speed of MT 100 falls within a certain predetermined range that does not exceed the predetermined speed limit (“No” path from decision step 708), then method 700 proceeds to method step 712, and use of all of the functionality of MT 100 is retained by the user, as described above in regard to method 500.

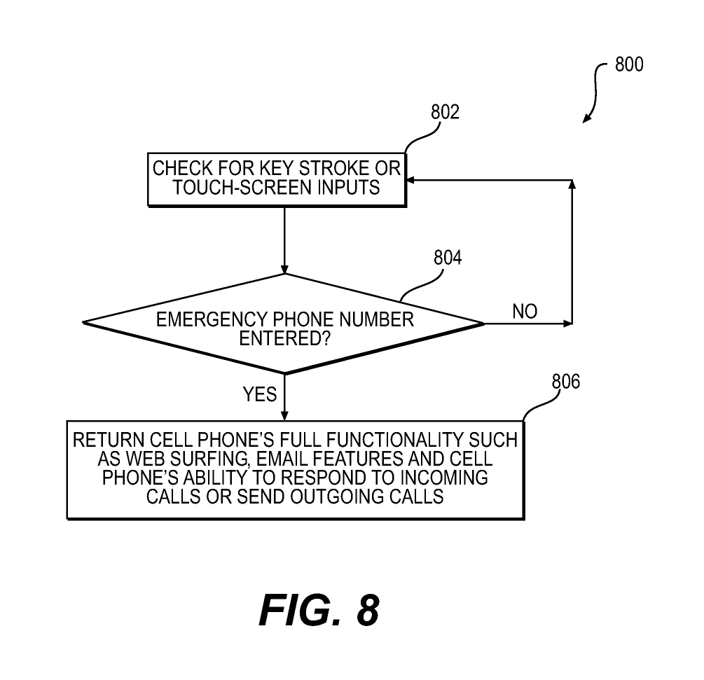

FIG. 8 illustrates a flow chart of method 800 for substantially ensuring emergency use of MT 100 at substantially any time by substantially anyone according to aspects of the embodiments. Method 800 begins with method step 802, wherein, regardless of a speed, location, time of day, or date, keystrokes are monitored to determine, in decision step 804, whether the keystrokes are related to an emergency phone number. As those of skill in the art can appreciate, emergency phone numbers can comprise more than “911.” They can include phone numbers or email addresses for the Center for Disease Control (CDC), phone numbers of a fire or police department, or hazardous materials treatment centers, Poison Control phone numbers, and so on. Further, certain people can have access to numbers that other people might not (for example a government employee could have access to a special FBI phone number), and those types of numbers can be programmed into a database for use by MTRF 102 according to aspects of the embodiments.

If the keystrokes entered in method step 802 are determined to be related to an emergency response service provider (“Yes” path from decision step 804), then method 800 proceeds to step 806 wherein full functionality is retained or returned to MT 100; but if the keystrokes are not related to any known emergency response service provider (“No” path from decision step 804), then method 800 returns to step 802 and continues to check the keystrokes, and continues to deny full functionality (presuming that full functionality has been denied for reasons related to those as described above, and particularly in regard to FIGS. 5, 6, and 7.

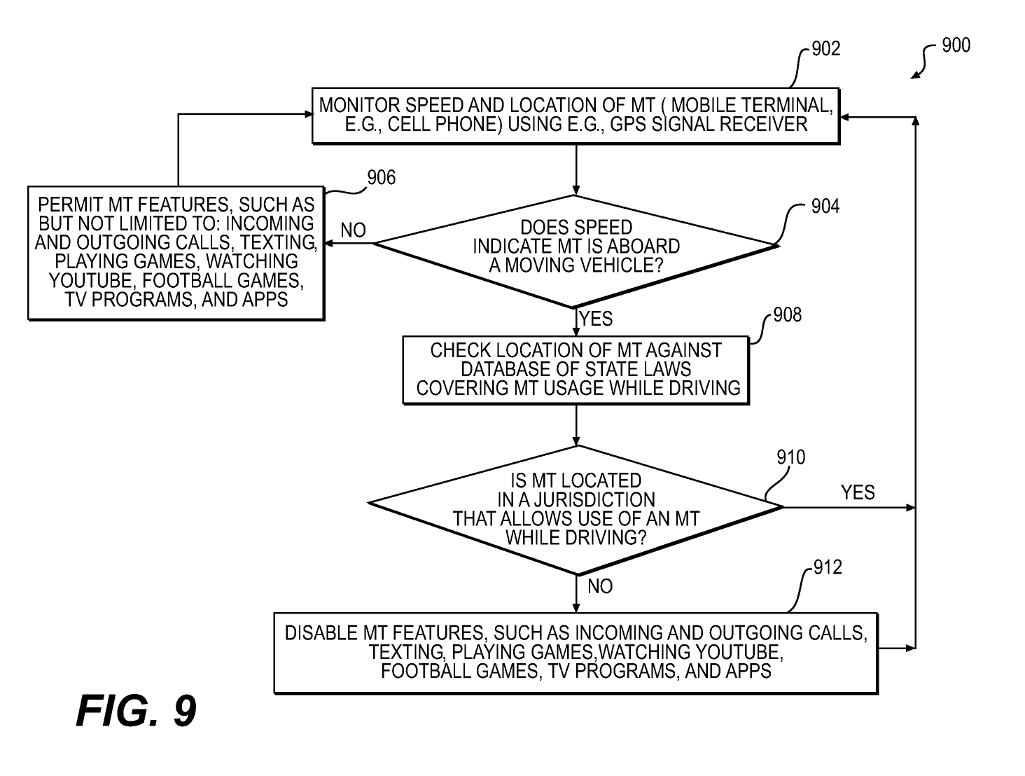

FIG. 9 illustrates a flow chart of method 900 for substantially reducing the functionality of MT 100 as a function of speed, location and cell phone usage laws while driving or moving within a locality according to an aspect of the embodiments. Method 900 begins with method step 902, wherein MTRF App 102 monitors the speed and location of MT 100 according to an embodiment. Monitoring the speed and location of MT 100 can be accomplished through MTRF App 102 through use of processor 104, and PDU/MDS 120, as described above. Following method step 902, method 900 proceeds to decision step 904 wherein method 900 determines whether MT 100 is aboard a moving vehicle. According to aspects of the embodiments, MTRF App 102 can generally ascertain with certainty that MT 100 is aboard a moving vehicle based on the speed MT 100 is traveling, especially if monitored over a period of time, and the path that MT 100 travels, e.g., on a highway or roadway. If it is determined that MT 100 is not aboard a moving vehicle (“No” path from decision step 904), then method 900 proceeds to step 906 wherein full functionality is allowed for MT 100. According to aspects of the embodiments, it is possible for MT 100 to be moving at some speed—e.g., if carried while walking, jogging, or riding a bike, for example, and at such speeds and at such activities are very unlikely to be harmful to third parties.

If it is determined, however, that MT 100 is aboard a moving vehicle (“Yes” path from decision step 904), method 900 proceeds to step 908 wherein a database of state and/or federal laws regarding usage of MT 100 while in a moving vehicle are checked (it is possible that a user with MT 100 can be traveling on Federal park lands, and the laws therein regarding use of MT 100 can differ from local surrounding areas). Following method step 908, method 900 determines in decision step 910 whether the jurisdiction that MT 100 is traveling in allows use of MT 100 while driving. Method 900 differs in this regard, from method 500, in that it is presumed a more experienced driver is using MT 100 in method 900, as opposed to an inexperienced driver in regard to method 500. Thus, a more experienced driver is generally considered capable of better decision making skills, and coordination of responses even while using MT 100. However, if local laws (whether state or federal), prohibit such usage, method 900 according to aspects of the embodiments can substantially prevent a user from inadvertently getting a ticket or citation, or causing an accident.

If the local jurisdiction allows usage of MT 100 while traveling aboard a vehicle (“Yes” path from decision step 910), method 900 returns to method step 902 to monitor the speed and location of MT 100. If, however, it is determined through the review of local/federal laws that usage of MT 100 is prohibited aboard a moving vehicle (“No” path from decision step 910), then method 900 disables the full functionality of MT 100, and returns to step 902 to continue to monitor speed and location of MT 100 according to embodiments. It should be understood by those of skill in the art, that what is meant by “full functionality” means any function of MT 100 that can or does require user input or interface in order to operate. Thus, MT 100 can and will continue to receive calls, texts, emails, and so on, but MTRF App 102 will, when full functionality of MT 100 is prohibited, not allow the user to see or access any of those items, to make calls or send texts, to play games, or even get updated information on such things as the weather, according to aspects of the embodiments.

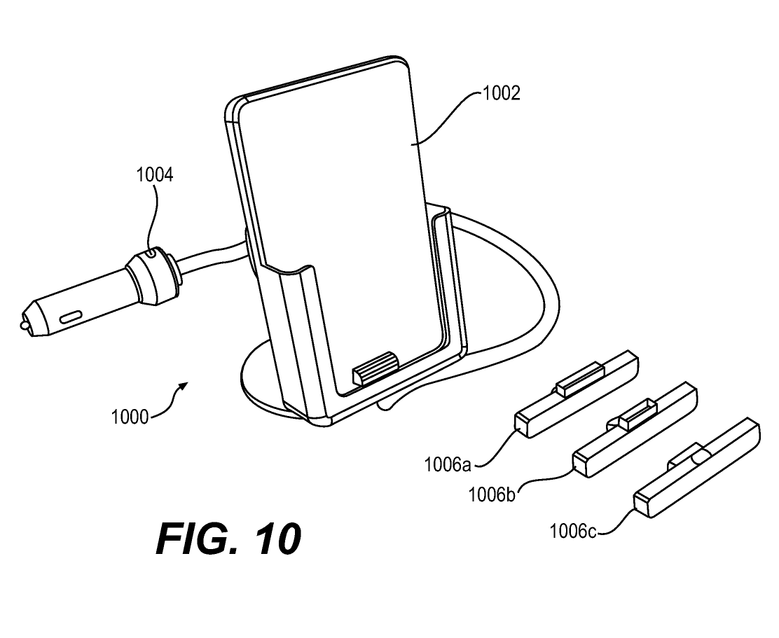

FIG. 10 illustrates a perspective view of mobile terminal charging station 1000 according to an aspect of the embodiments. Mobile terminal charging station 1000 provides a convenient manner of holding and charging MT 100 when in an auto, or any other vehicle that has a light plug that can provide the appropriate voltage. Mobile terminal charging station 1000 includes cradle 1002, adaptors 1006a-c, and lighter plug 1004 according to an embodiment. Adaptors 1006a-c can be swapped into a bottom portion of cradle 1002 in order to allow different types of MT 100 to be held by cradle 1002 when charging according to an embodiment.

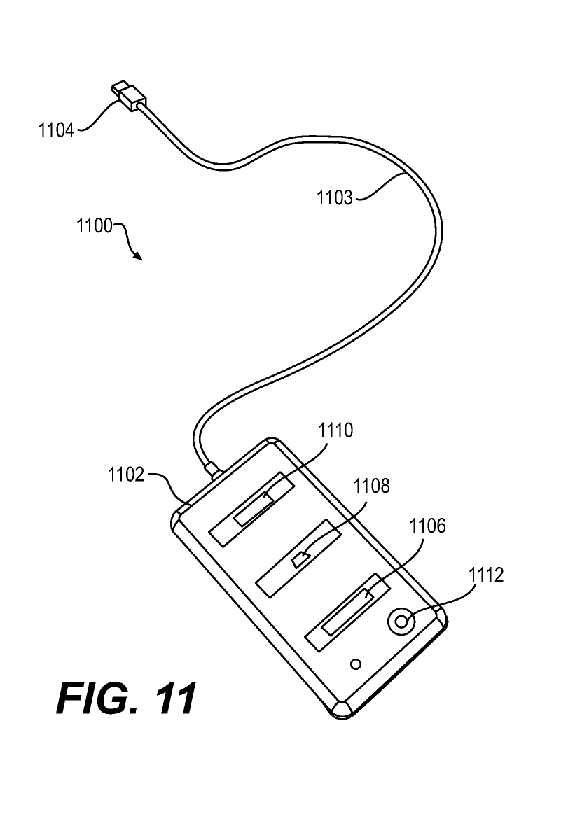

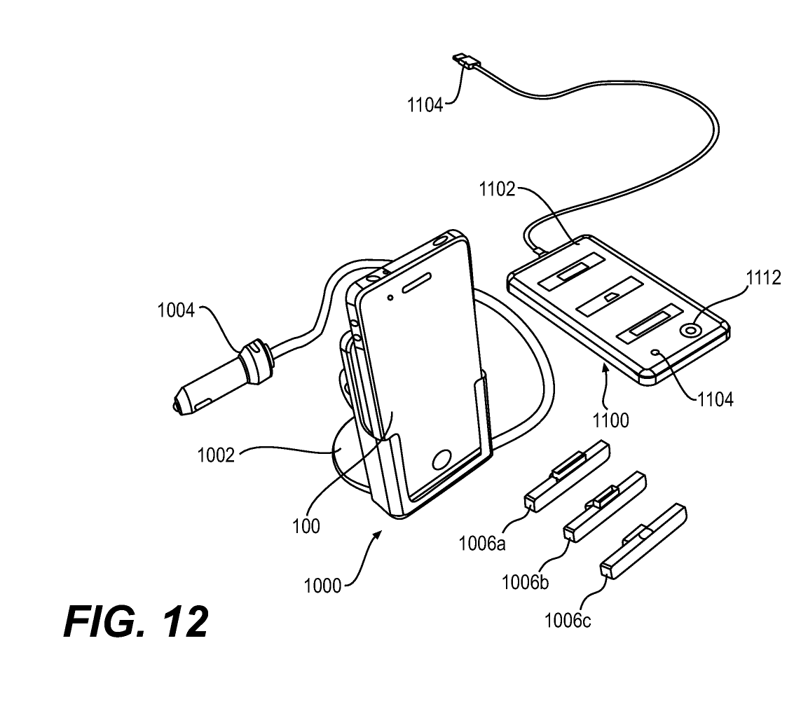

FIG. 11 illustrates a perspective view of mobile terminal charging station 1100 for use at home according an aspect of the embodiments. Mobile terminal charging station 1100 includes computer adaptor 1102, universal serial bus (USB) cable 1103, USB connector 1104, smart phone input 1106, cell phone input 1108, USB input 1110, power indicator 1112, and light emitting diode (LED) charging indicator 1114 according to an embodiment. FIG. 12 illustrates a perspective view of the mobile terminal charging stations 1000, 1100 of FIGS. 10 and 11 with MT 100 in mobile terminal charging station 1000 of FIG. 10 according to an aspect of the embodiments.

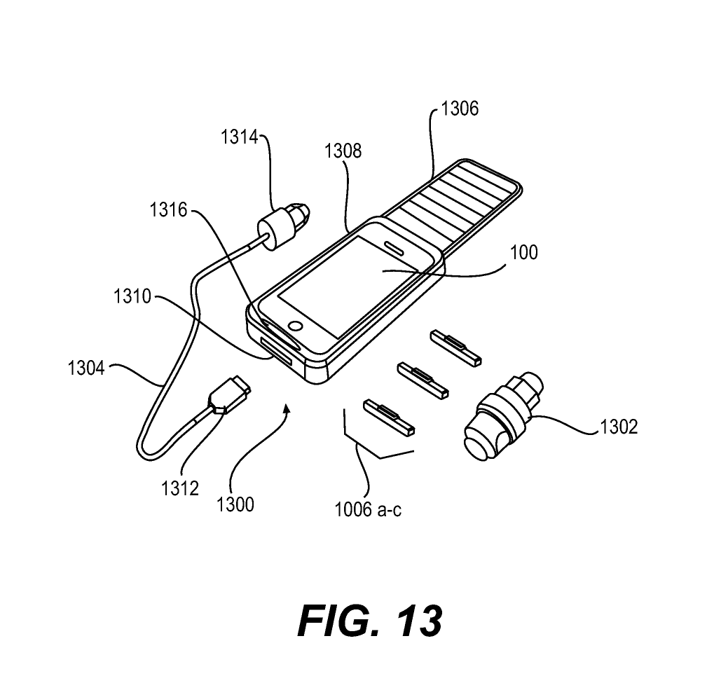

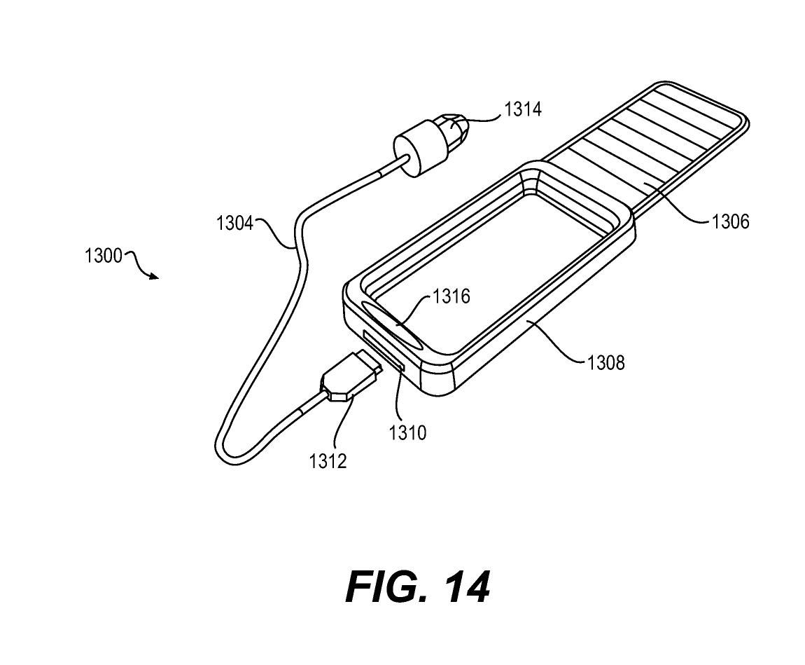

FIGS. 13, 14, 15, and 16 illustrate several perspective views of mobile terminal charging station (MTCS) 1300 that substantially prevents usage while driving or charging according to a further aspect of the embodiments. MTCS 1300 can be used with any type of MT 100 according to aspects of the embodiments. MTCS 1300 includes first lighter plug 1302, charging cable 1304, sliding cover 1306, case 1308, USB port 1310, USB cable connector 1312, cable lighter plug 1314, and charging station circuitry 1316 according to embodiments. FIG. 13 illustrates MTCS 1300 in an open configuration, with MT 100 located therein, and FIG. 14 shows MTCS 1300 also open, but devoid of MT 100. Cable lighter plug 1314 connects into a standard cigarette lighter, found in most if not all autos, and allows power to be transferred from the auto by charging cable 1304 through USB cable connect 1312, which is connected to USB port 1306 on case 1308. MT 100 fits into case 1308, and through use of one of adaptors 1006a-c, is connected to the power provided by the auto via a cigarette lighter. (e.g., a cigarette lighter adapted to both light a cigarette and also functions as a DC (direct current) outlet to charge mobile terminals such as cell phones, or MTs 100).

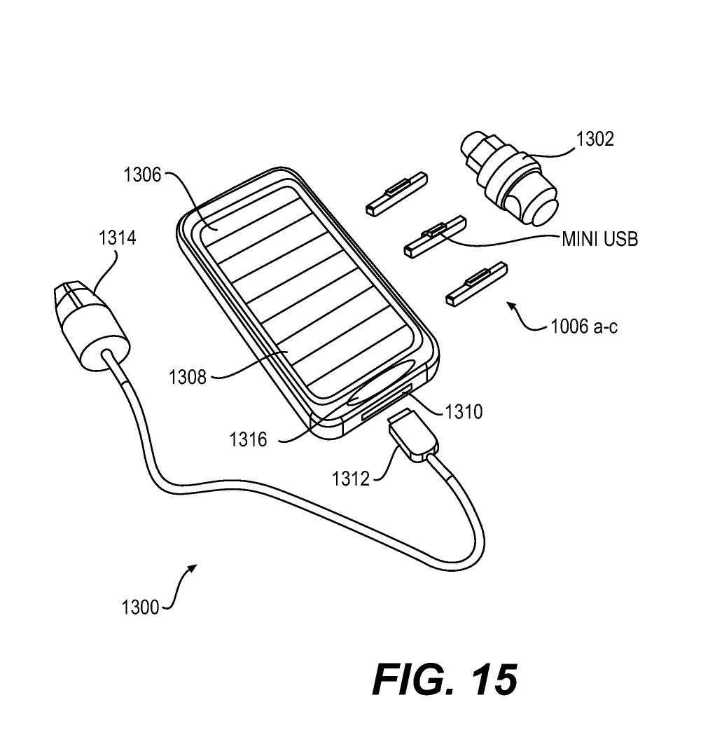

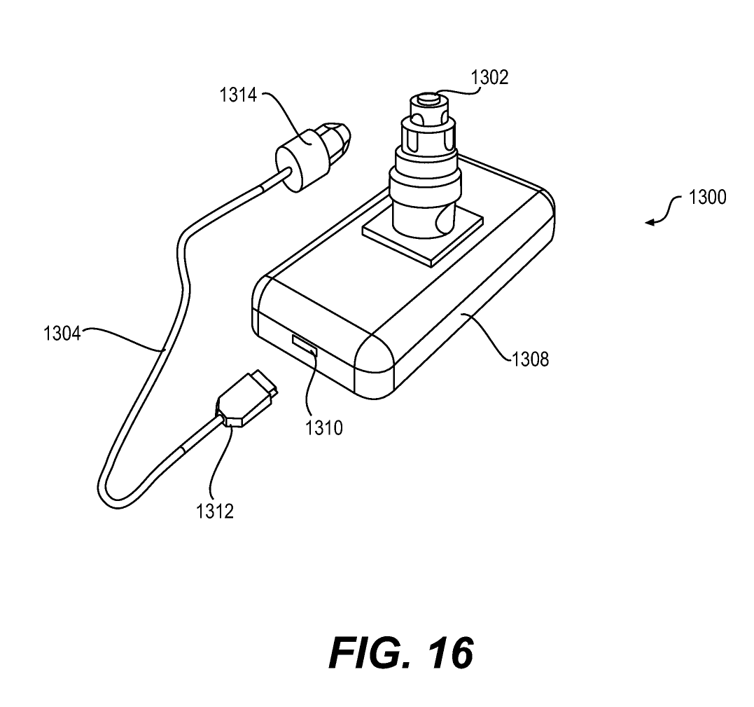

Use of MTCS 1300 according to an embodiment is as follows. According to a first use, a user would first insert MT 100 into case 1308. Then, the car would be started. As soon as power flows into MT 100, circuitry 1316 recognizes the charging condition and causes sliding cover 1306 to close over MT 100; according to an embodiment, this substantially prevents its use while power is being transferred to MT 100 (generally, when the car is operating, though that not always need be the situation). According to another embodiment, circuitry 1316 receives a notification from MTRF App 102 as soon as the auto or vehicle starts moving, and then causes sliding cover 1306 to close. The notification from MTRF 102 is generated by use of processor 104, MTRF App 104, and PDU/MDS 120 that in conjunction with each other, generates a signal that indicates motion or movement has been detected of MT 100, as described in greater detail above. FIG. 15 illustrates MTCS 1300 after sliding cover 1306 has slid shut; according to a further embodiment, sliding cover 1306 will not shut unless the presence of MT 100 has been detected within MTCS 1300; according to a further aspect of the embodiments, that need not be the case. Adapters 1006a-c allow for different types of MTs 100 to be placed and charged within MTCS 1300 according to aspects of the embodiments. As shown in FIG. 16, first lighter plug 1302 can connect to a connector located on a back side of MTCS 1300 and then connect directly into an auto's cigarette lighter to receive power. In this manner, MTCS 1300 can be conveniently place in a position that is not in the way of either ordinary operation of the vehicle, and is further not located on a passenger's seat.

As those of skill in the art can appreciate, various mechanisms can be used to cause sliding cover 1306 to move upon receipt of a proper signal. Sliding cover 1306 can be controlled by tiny servo motors, or springs (not shown), all of which are considered to be within the scope of the aspects of the embodiments. Further, circuitry 1316 can be well understood by those of skill in the art, and thus a detailed discussion thereof has been omitted in fulfillment of the dual purposes of clarity and brevity.

As described above, one or more encoding processes are discussed in reference to FIGS. 5, 6, 7, 8 and 9. The encoding processes are not meant to limit the aspects of the embodiments, or to suggest that the aspects of the embodiments should be implemented following the encoding process. The purpose of the encoding processes is to facilitate the understanding of one or more aspects of the embodiments and to provide the reader with one or many possible implementations of the processed discussed herein. FIGS. 5, 6, 7, 8, and 9 illustrate flowcharts of various steps performed during the encoding processes. The steps of FIGS. 5, 6, 7, 8, and 9 are not intended to completely describe the encoding process but only to illustrate some of the aspects discussed above.

As also will be appreciated by one skilled in the art, the various functional aspects of the embodiments can be embodied in MT 100. Accordingly, the embodiments can take the form of an entirely hardware embodiment or an embodiment combining hardware and software aspects. Further, the embodiments can take the form of a non-transitory computer program product stored on a computer-readable storage medium having computer-readable instructions embodied in the medium. Any suitable computer-readable medium can be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable, volatile/nonvolatile, and transitory/non-transitory computer storage media. For example, the processor can access a hard disk drive that reads from or writes to non-removable, nonvolatile, and non-transitory magnetic media, a magnetic disk drive that reads from or writes to a removable, nonvolatile, and non-transitory magnetic disk, and/or an optical disk drive that reads from or writes to a removable, nonvolatile, and non-transitory optical disk, such as a CD-ROM or other optical media. Other removable/non-removable, volatile/nonvolatile, and non-transitory computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

The disclosed embodiments provide a source array, computer software, and a method for reducing functionality of MT 100 in some situations, and restoring it in other situations. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments can be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

I claim:

1. A method for reducing functionality of a mobile terminal (500), the method comprising:
monitoring a speed of a mobile terminal (502);
determining that the speed of the mobile terminal exceeds a predetermined threshold (504) and reducing the functionality of the mobile terminal until the speed falls below the predetermined threshold (506); and
determining that the speed of the mobile terminal does not exceed the predetermined threshold (504) and continuing to monitor the speed of the mobile terminal without reducing the functionality of the mobile terminal (508).

2. The method according to claim 1, wherein the step of reducing the functionality of the mobile terminal comprises:
shutting down one or more of the functions of receiving and placing calls, receiving and sending text messages, using an internet web browser, receiving and sending electronic mail messages, taking and viewing photos, downloading data and/or applications, and playing games.

3. The method according to claim 1, wherein the mobile terminal comprises:
one of a cellular telephone, a tablet, a laptop, and a personal digital assistant, and further wherein the cellular telephone comprises
one of a third generation (3G) communications protocol cellular telephone, a fourth generation (4G) communications protocol cellular telephone, and 4G-long term evolution (LTE) communications protocol cellular telephone.

4. The method according to claim 1, wherein the step of determining that the speed of the mobile terminal exceeds a predetermined threshold comprises:
setting the predetermined threshold on the basis of a moving vehicle.

5. The method according to claim 1, wherein the step of monitoring a speed of the mobile terminal comprises:
using a position determining unit of the mobile terminal to determine and monitor the speed of the mobile terminal.

6. The method according to claim 5, wherein the step of using a position determining unit comprises:
receiving and processing on a substantially continuous basis global positioning system signals to ascertain a position, and a change in position over time, so that an average speed of the mobile terminal can be substantially constantly ascertained.

7. The method according to claim 6, wherein the step of using a position determining unit further comprises:
using an inertial navigation system to augment the ascertainment of the position and speed of the mobile terminal.

8. The method according to claim 6, wherein the step of using a position determining unit further comprises:
using cellular based positioning determining processes to augment the ascertainment of the position and speed of the mobile terminal.

9. A method for reducing functionality of a mobile terminal (600), the method comprising:
determining a location of the mobile terminal (608); and
reducing the functionality of the mobile terminal if the location of the mobile terminal matches that of a predetermined list of locations wherein usage of the mobile terminal is substantially prohibited.

10. The method according to claim 9, further comprising:
determining a date and time of a usage of the mobile terminal; and
reducing the functionality of the mobile terminal if the current date and time is such that usage of the mobile terminal is substantially prohibited at the determined location of the mobile terminal.

11. The method according to claim 9, wherein
the predetermined list of locations comprises one or more of a school, religious institution, and government building, and further wherein the date and time of usage that is substantially prohibited comprises
one of a normal work day and working times, and a normal school day and school attendance times.

12. A method for reducing functionality of a mobile terminal (700), the method comprising:
monitoring a speed of a mobile terminal (702);
determining that the mobile terminal is operated by a protected person (704); and
continuing to monitor the speed of the mobile terminal and reducing a position determining functionality of the mobile terminal (706).

13. The method according to claim 12, further comprising:
determining that the mobile terminal is not operated by a protected person (704);
determining that the speed of the mobile terminal exceeds a predetermined threshold (708) and reducing the functionality of the mobile terminal until the speed falls below the predetermined threshold (710); and
determining that the speed of the mobile terminal does not exceed the predetermined threshold (708) and continuing to monitor the speed of the mobile terminal without reducing the functionality of the mobile terminal (712).

14. A method for alleviating a reduction in functionality of a mobile terminal (800), the method comprising:
reducing the functionality of the mobile terminal;
checking one or more keystrokes entered by a user of the mobile terminal (802);
determining that an emergency number has been dialed by comparing the entered keystrokes to a plurality of stored emergency numbers (804); and
returning full functionality to the mobile terminal upon the determination that the entered keystrokes are that of a stored emergency number (806).

15. The method according to claim 14, further comprising:
determining that an emergency number has not been dialed, and continuing to maintain the reduced functionality of the mobile terminal (804).

16. A method for reducing functionality of a mobile terminal (900), the method comprising:
monitoring a speed and location of a mobile terminal (902);
determining that the speed of the mobile terminal indicates that the mobile terminal is aboard a moving vehicle (904);
obtaining a list of regulations governing usage of the mobile terminal while aboard a moving vehicle (908) at the location of the moving vehicle;
determining that the mobile terminal is in a location that prohibits usage of the mobile terminal while aboard the moving vehicle (910); and
reducing the functionality of the mobile terminal (912).

17. The method according to claim 16, further comprising:
determining that the speed of the mobile terminal does not indicate that the mobile terminal is on board a moving vehicle (904); and
continuing to monitor the speed of the mobile terminal without reducing the functionality of the mobile terminal (906).

18. The method according to claim 16, further comprising:
determining that the mobile terminal is in a location that does not prohibits usage of the mobile terminal while aboard the moving vehicle (910); and
continuing to monitor the speed of the mobile terminal without reducing the functionality of the mobile terminal (902).

19. A reduced functionality charging apparatus (1300) for a mobile terminal (100) comprising:
a cable and connector (1304) adapted to connect the charging apparatus to a direct current source for charging the mobile terminal;
a case (1308) adapted to retain and hold within itself the mobile terminal and to provide interconnections to provide for charging of the mobile terminal; and
a cover (1306) adapted to be controlled by a circuit (1316) to substantially cover and prevent access to the mobile terminal, and wherein
the circuit is adapted to close the cover upon determining that the mobile terminal is at least one of (a) moving on board a vehicle, and (b) charging.

20. The reduced functionality charging apparatus further comprising:
a connected adapted to plug directly into the direct current source without an intervening cable (1302) for charging the mobile terminal.
